(19) United States
(12) Patent Application Publication
(10) Pub. No.: US 2014/0137705 A1
(43) Pub. Date: May 22, 2014

(54) SCREW-REMOVING DEVICE

(71) Applicants: Hon Hai Precision Industry Co., Ltd., New Taipei (TW); Fu Ding Electronical Technology (Jiashan) Co., Ltd., Zhejiang (CN)

(72) Inventors: WEI SHEN, Jiashan (CN); XIN-HONG LU, Jiashan (CN); JIAN-JIAN YANG, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/082,187

(22) Filed: Nov. 17, 2013

(30) Foreign Application Priority Data
Nov. 19, 2012 (CN) 2012206121133

(51) Int. Cl. B23P 19/06

(52) U.S. Cl. CPC B23P 19/06
USPC 81/57.4

(57) ABSTRACT

A screw-removing device used for removing a number of screws screwed into a workpiece includes a support frame, a removing mechanism, a positioning mechanism, and a transporting mechanism. The removing mechanism includes a first driving member mounted on the support frame and a number of universal shafts. The universal shaft comprises a main body, a transmitting portion connected to the first driving member, and a connection portion. A removing member is connected to the connection portion. The positioning mechanism is mounted in the support frame to position the workpiece below the removing member. The transporting mechanism is mounted on the support frame to transport the workpiece to the positioning mechanism.

### BACKGROUND

1. Technical Field

The present disclosure generally relates to screw-removing devices, and particularly to a screw-removing device capable of removing screws from workpieces.

2. Description of Related Art

In order to improve an efficiency of removing screws from workpieces, a screw-removing device is employed to remove the screws. The screw-removing device includes a driver and a removing member. The removing member moves along an X-Y direction driven by the driver to remove the screws. However, if a position of the screw changes a little, it is difficult to realign the removing member with the screw.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows one embodiment of a screw-removing device in a state of use.

FIG. 2 is similar to FIG. 1, but viewed from another aspect.

FIG. 3 shows a partially exploded, isometric view of the screw-removing device shown in FIG. 1.

FIG. 4 shows an enlarged view of a circled portion IV of FIG. 3 showing universal shafts of the screw-removing device.

FIG. 5 shows another embodiment of a universal shaft.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

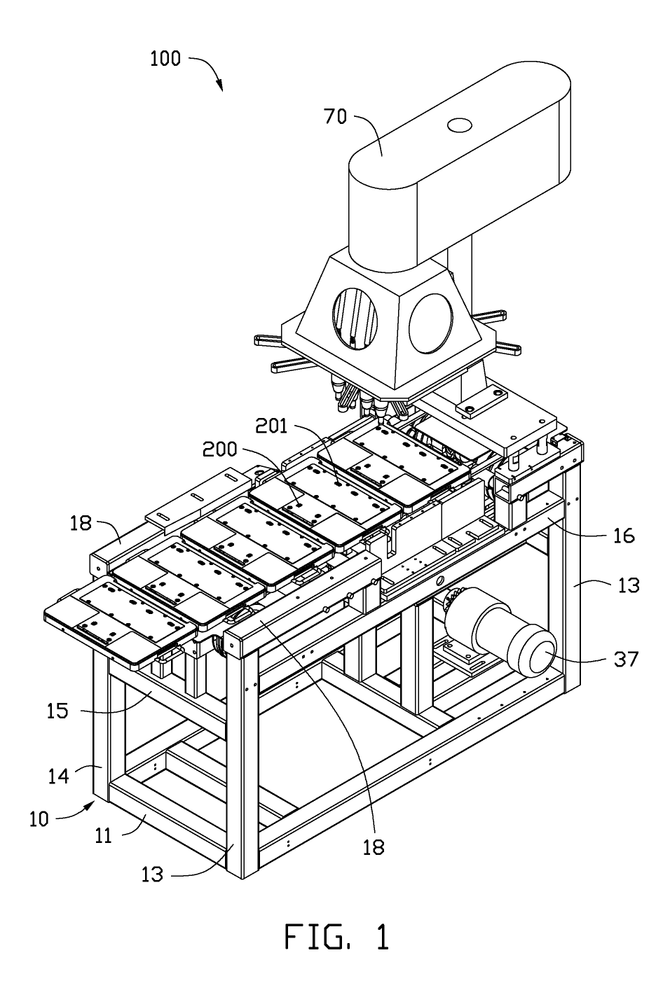

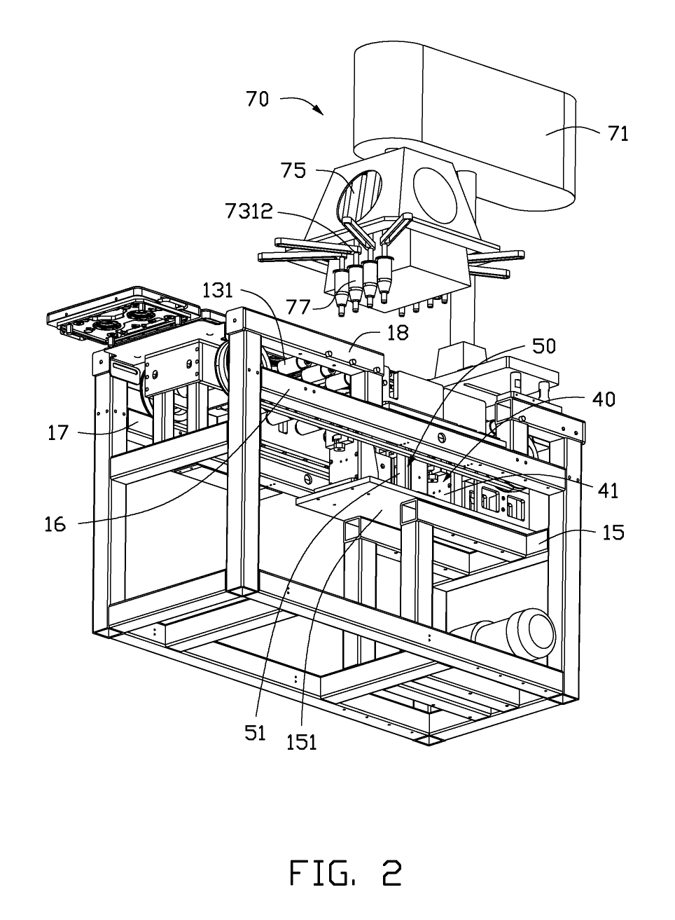

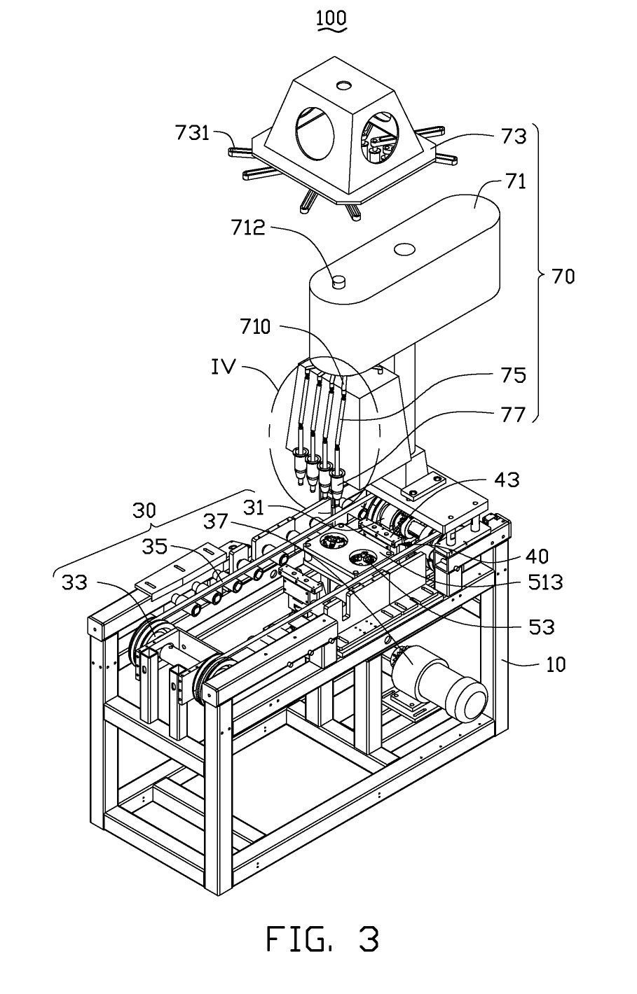

FIGS. 1 and 2 show an embodiment of a screw-removing device 100 for removing a plurality of screws 201 screwed into a plurality of workpieces 200. In the illustrated embodiment, eight screws 201 are screwed into one workpiece 200. The screw-removing device 100 includes a support frame 10, a transporting mechanism 30 (shown in FIG. 3), a positioning mechanism 50, and a removing mechanism 70. The transporting mechanism 30 is mounted on the support frame 10 for transporting the workpieces 200 to a position above the positioning mechanism 50. The workpieces 200 are positioned by the positioning mechanism 50 and transported to the removing mechanism 70. The screws 201 are removed from the workpieces 200 by the removing mechanism 70.

The support frame 10 is substantially frame-like and includes a bottom frame 11, two first legs 13, two second legs 14, two end crossbeams 15, a first side crossbeam 16, and a second side crossbeam 17. The bottom frame 11 is substantially rectangular. The two first legs 13 are mounted substantially perpendicularly to two corners of the bottom frame 11. The two second legs 14 are mounted substantially perpendicularly to other two corners of the bottom frame 11. Opposite ends of each end crossbeam 15 are connected to one corresponding first leg 13 and one corresponding second leg 14, respectively. Opposite ends of the first side crossbeam 16 are connected to the two first legs 13, respectively, and the first side crossbeam 16 is above the end crossbeams 15. Opposite ends of the second side crossbeam 17 are connected to the two second legs 14, respectively, and the second side crossbeam 17 is above the end crossbeams 15. The support frame 10 further includes a support plate 151 and a plurality of rotation members 131. The support plate 151 is mounted on one end crossbeam 15 and extends toward an inner space or region of the support frame 10. The support plate 151 is substantially parallel to the bottom frame 11. The support frame 10 further includes two mounting beams 18. One end portion of one mounting beam 18 is mounted substantially perpendicularly on a free end of the first leg 13 away from the support plate 151, and positioned above and substantially parallel to the first side crossbeam 16. One end portion of the other mounting beam 18 is mounted substantially perpendicularly on a free end of the second leg 14 away from the support plate 151, and positioned above and substantially parallel to the second side crossbeam 17. The rotation members 131 are rotatably-mounted to inner sides of the two mounting beams 18.

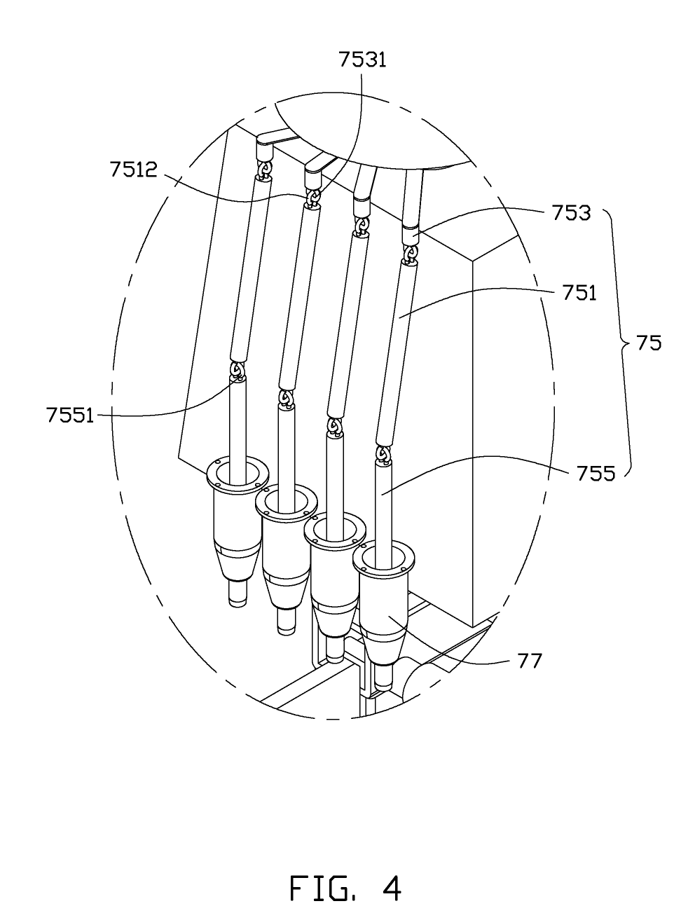

Referring also to FIGS. 3 and 4, the transporting mechanism 30 is mounted on the support frame 10. The transporting mechanism 30 includes a first rotation shaft 31, a second rotation shaft 33, two transporting belts 35, and a first driving member 37. The first rotation shaft 31 is rotatably-mounted on a corresponding end crossbeam 15 by a support structure (not labeled), and is positioned above the support plate 151. The second rotation shaft 33 is rotatably-mounted on a corresponding end crossbeam 15 by another support structure (not labeled). Each transporting belt 35 is wrapped around one end of the first rotation shaft 31 and one end of the corresponding second rotation shaft 33. The two transporting belts 35 are spaced from each other. The transporting belts 35 resist against the rotation members 131. The first driving member 37 is mounted on the bottom frame 11 and connected to the first rotation shaft 31 to drive the first rotation shaft 31 to rotate. The first rotation shaft 31 rotates the second rotation shaft 33 by the two transporting belts 35, and the two transporting belts 35 are rotated by the first rotation shaft 31.

In one illustrated embodiment, the screw-removing device 100 further includes a blocking assembly 40. The blocking assembly 40 is mounted on the support plate 151, and includes a second driving member 41 and a blocking portion 43 connected to the second driving member 41. The second driving member 41 is mounted on the support plate 151. The blocking portion 43 is driven by the second driving member 41 to protrude out from the support frame 10 to block one workpiece 200 and keep the workpiece 200 above the positioning mechanism 50.

The positioning mechanism 50 is mounted on the support plate 151 and adjacent to the blocking portion 43. The positioning mechanism 50 includes a third driving member 51 and a plurality of fixing members 53. The third driving member 51 is mounted on the support plate 151 and is adjacent to the second driving member 41. The fixing members 53 are connected to and driven by the third driving member 51. The fixing members 53 are spaced from each other and are driven by the third driving member 51 to latch with bottom edges of a workpiece 200 and move the workpiece 200 to the removing mechanism 70.

The removing mechanism 70 is mounted on the support frame 10 and above the first rotation shaft 31. The removing mechanism 70 includes a fourth driving member 71, a protection cover 73, eight universal shafts 75, and eight removing members 77 corresponding to the eight universal shafts 75 one-to-one. The fourth driving member 71 includes a driving shaft 712. The protection cover 73 covers the universal shafts 75. A plurality of limiting members 731 are connected to the protection cover 73 and are positioned corresponding to positions of the removing members 77. A limiting hole 7312 is defined in each limiting member 731. Each universal shaft 75 is received through one corresponding limiting hole 7312 and is connected to the driving shaft 712 by one belt 710. Each universal shaft 75 includes a main body 751, a transmitting portion 753, and a connection portion 755. The transmitting portion 753 and the connection portion 755 are rotatably-connected to opposite ends of the main body 751, respectively. The main body 751, the transmitting portion 753, and the connection portion 755 are substantially rod-shaped. One end of the transmitting portion 753 is connected to and driven by the driving shaft 712 by the belts 710. A first latching member 7512 is fixed to each end of the main body 751. A second latching member 7531 is fixed to one end of the transmitting portion 753 and connected to the first latching member 7512 of the main body 751 to connect the transmitting portion 753 to the main body 751. A third latching member 7551 is fixed to one end of the connection portion 755 and connected to the first latching member 7512 of the main body 751 to connect the connection portion 755 to the main body 751. The second latching member 7531 and the third latching member 7551 are each rotatably-connected to one corresponding first latching member 7512. Thus, the transmitting portion 753 and the connection portion 755 are rotatably-connected to opposite ends of the main body 751, respectively. The main bodies 751 are received in the protection cover 73. The connection portion 755 is received through the limiting hole 7312, and partly protrudes out from the protection cover 73. Each removing member 77 is fixedly-connected to a free end of a corresponding connection portion 755.

In assembly, the first rotation shaft 31 and the second rotation shaft 33 each are rotatably-mounted on a corresponding end crossbeam 15 by a corresponding supporting structure. The first driving member 37 is connected to the first rotation shaft 31. The two transporting belts 35 are rotatably-connected to the first rotation shaft 31 and the second rotation shaft 33, respectively, and resist against the rotation members 131. The second driving member 41 is mounted on the support plate 151 and connected to the blocking portion 43. The two third driving members 51 are mounted on the support plate 151 adjacent to the second driving member 41, and are spaced from each other. The fixing members 53 are mounted on the third driving members 51. The protection cover 73 is mounted on the fourth driving member 71 and adjacent to one end of the fourth driving member 71. Each universal shaft 75 is received through a corresponding limiting hole 7312 to be mounted to the protection cover 73. Each removing member 77 is connected to the connection portion 755.

In use, the first driving member 37 drives the first rotation shaft 31 to rotate, and the first rotation shaft 31 rotates the second rotation shaft 33 by the transporting belts 35, such that the workpieces 200 are transported to the positioning mechanism 50 by the transporting belts 35 and blocked by the blocking assembly 40. The fixing members 53 are driven by the third driving member 51 to latch with the bottom edges of a workpiece 200 and move the workpiece 200 to the removing mechanism 70, such that the workpiece 200 resists against the removing members 77. The removing members 77 are (indirectly) rotated by the driving shaft 712 of the fourth driving member 71 to remove the corresponding screws 201. The fixing members 53 transport the workpiece 200 back to the transporting belts 35, so that the workpiece 200 is transported to a next station.

The removing members 77 are rotated by the fourth driving member 71, so that even if the screws 201 deviate a little, the removing members 77 can still align with the screws 201. Because the universal shafts 75 are broken up into different sections, a manufacturing process of the universal shafts 75 is simplified.

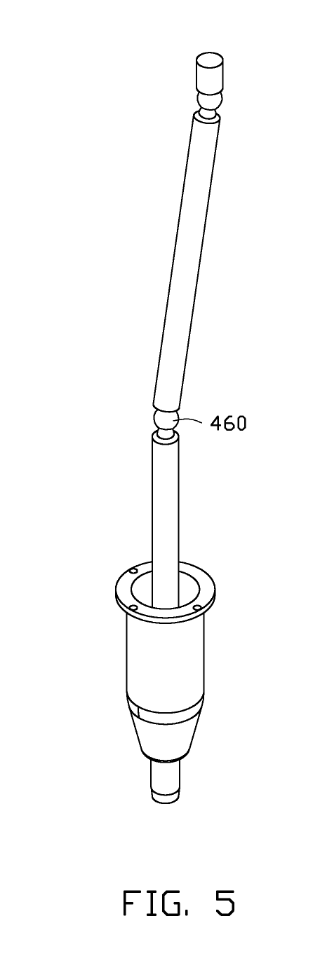

In other embodiments, the respective numbers of the universal shafts 75, the removing members 77, the rotation members 131, and the limiting members 731 can be changed as needed. The protection cover 73 can be omitted, such that the connection portion 755 is directly connected to the driving shaft 712. The blocking assembly 40 can be omitted, such that other structures are employed to position the workpiece 200. The first latching member 7512, the second latching member 7531, and the third latching member 7551 can be replaced with a plurality of universal joints 460, as shown in FIG. 5.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A screw-removing device, for removing a plurality of screws screwed into a workpiece, the screw-removing device comprising:
a support frame;
a removing mechanism comprising:
a fourth driving member mounted on the support frame,
at least one universal shaft comprising a main body, a transmitting portion connected to the fourth driving member, and a connection portion, the transmitting portion and the connection portion rotatably-connected to opposite ends of the main body, respectively,
and a removing member connected to the connection portion;
a positioning mechanism mounted in the support frame to position the workpiece below the removing member; and
a transporting mechanism mounted on the support frame to transport the workpiece to the positioning mechanism.

2. The screw-removing device of claim 1, wherein the positioning mechanism comprises a plurality of fixing members and a third driving member, the third driving member is mounted in the support frame, the plurality of fixing members are connected to and driven by the third driving member and capable of partly protruding out from the support frame, so that the plurality of fixing members move to latch with bottom edges of the workpiece to move the workpiece to the removing member.

3. The screw-removing device of claim 1, wherein the universal shaft further comprises two first latching members connected to the opposite ends of the main body, a second latching member mounted on one end of the transmitting portion connected to the main body, and a third latching member mounted on one end of the connection portion connected to the main body, the second latching member and the third latching member are rotatably latched with the corresponding first latching member, respectively, so that the transmitting portion and the connection portion are rotatably-connected to opposite ends of the main body, respectively.

4. The screw-removing device of claim 1, further comprising a protection cover, wherein the protection cover is mounted on one end of the fourth driving member, the fourth driving member and the at least one universal shaft are received in the protection cover, at least one limiting member is mounted on one end of the protection cover away from the fourth driving member, each of the at least one limiting member defines a limiting hole, each of the at least one universal shaft is received through the at the corresponding limiting hole.

5. The screw-removing device of claim 1, wherein the transporting mechanism comprises a first rotation shaft rotatably-mounted on the support frame, a second rotation shaft rotatably-mounted on the support frame, a transporting belt, and a first driving member connected to and capable of driving the first rotation shaft, the transporting belt is rotatably wrapped around the first rotation shaft and the second rotation shaft, respectively.

6. The screw-removing device of claim 5, wherein the support frame comprises a bottom frame, two first legs, two second legs, and two end crossbeams, the two first legs and the two second legs are mounted on four corners of the bottom frame toward a same side of the bottom frame, respectively, opposite ends of one of the two end crossbeams are connected to the one of the two first legs and the one corresponding second leg, opposite ends of the other one of the two end crossbeams are connected to the other one of the two first legs and the other one second leg, the first rotation shaft is rotatably-mounted on one of the two end crossbeams, the second rotation shaft is rotatably-mounted on the other one of the two end crossbeams.

7. The screw-removing device of claim 6, wherein the support frame further comprises a support plate, the support plate is mounted on one of the two end crossbeams toward inner region of the support frame and is parallel to the bottom frame, the positioning mechanism is mounted on the support plate.

8. The screw-removing device of claim 6, wherein the support frame further comprises two mounting beams and a plurality of rotation members, one of the two mounting beams is placed on a free end of one of the two first legs away from the support plate, the other one of the two mounting beams is placed on a free end of one of the two second legs away from the support plate, the plurality of rotation members is rotatably-mounted on the two mounting beams toward inner region of the support frame, the transporting belt resists against the plurality of rotation members.

9. The screw-removing device of claim 1, further comprising a blocking assembly, wherein the blocking assembly comprises a second driving member and a blocking portion connected to and driven by the second driving member, the second driving member is mounted on the support frame, the blocking portion is driven by the second driving member to be movable relative to the support frame and capable of protruding out from the support frame to block the workpiece.

10. The screw-removing device of claim 1, further comprising a plurality of universal joints, wherein the opposite ends of the main body are rotatably-connected to the transmitting portion and the connection portion by the plurality of universal joints, respectively.

11. A screw-removing device, for detaching a plurality of screws screwed into a workpiece, the screw-removing device comprising:
a support frame;
a removing mechanism comprising:
a fourth driving member mounted on the support frame,
a universal shaft comprising a main body, a transmitting portion connected to the fourth driving member, and a connection portion, the transmitting portion and the connection portion rotatably-connected to opposite ends of the main body, respectively,
and a removing member connected to the connection portion;
a positioning mechanism mounted in the support frame to position the workpiece below the removing member, the positioning member comprising:
a plurality of fixing members, and
a third driving member, wherein the plurality of fixing members is connected to and driven by the third driving member and capable of partly protruding out from the support frame, so that the plurality of fixing members move to latch with a bottom portion of the workpiece to move the workpiece to the removing member;
a transporting mechanism mounted on the support frame to transport the workpiece to the positioning mechanism; and
a protection cover mounted on one end of the fourth driving member, the fourth driving member and the universal shaft received in the protection cover, a limiting member mounted on one end of the protection cover away from the fourth driving member, the limiting member defining a limiting hole, the universal shaft received through the limiting hole.

12. The screw-removing device of claim 11, wherein the universal shaft further comprises two first latching members connected to the opposite ends of the main body, a second latching member mounted on one end of the transmitting portion connected to the main body, and a third latching member mounted on one end of the connection portion connected to the main body, the second latching member and the third latching member are rotatably latched with the corresponding first latching member, respectively, so that the transmitting portion and the connection portion are rotatably-connected to opposite ends of the main body, respectively.

13. The screw-removing device of claim 11, wherein the transporting mechanism comprises a first rotation shaft rotatably-mounted on the support frame, a second rotation shaft rotatably-mounted on the support frame, a transporting belt, and a first driving member connected to and capable of driving the first rotation shaft, the transporting belt is rotatably wrapped around the first rotation shaft and the second rotation shaft, respectively.

14. The screw-removing device of claim 13, wherein the support frame comprises a bottom frame, two first legs, two second legs, and two end crossbeams, the two first legs and the two second legs are mounted on four corners of the bottom frame toward a same side of the bottom frame, respectively, opposite ends of one of the two end crossbeams are connected to the one of the two first legs and the one corresponding second leg, opposite ends of the other one of the two end crossbeams are connected to the other one of the two first legs and the other one second leg, the first rotation shaft is rotatably-mounted on one of the two end crossbeams, the second rotation shaft is rotatably-mounted on the other one of the two end crossbeams.

15. The screw-removing device of claim 14, wherein the support frame further comprises a support plate, the support plate is mounted on one of the two end crossbeams toward inner region of the support frame and is parallel to the bottom frame, the positioning mechanism is mounted on the support plate.

16. The screw-removing device of claim 15, wherein the support frame further comprises two mounting beams and a plurality of rotation members, one of the two mounting beams is placed on a free end of one of the two first legs away from the support plate, the other one of the two mounting beams is placed on a free end of one of the two second legs away from the support plate, the plurality of rotation members is rotatably-mounted on the two mounting beams toward inner region of the support frame, the transporting belt resists against the plurality of rotation members.

17. The screw-removing device of claim 11, further comprising a blocking assembly, wherein the blocking assembly comprises a second driving member and a blocking portion connected to and driven by the second driving member, the second driving member is mounted on the support frame, the blocking portion is movable relative to the support frame when driven by the second driving member and capable of protruding out from the support frame to block the workpiece.

18. The screw-removing device of claim 11, further comprising a plurality of universal joints, wherein the opposite ends of the main body are rotatably-connected to the transmitting portion and the connection portion by the plurality of universal joints, respectively.
